(19) United States
(12) Patent Application Publication
(10) Pub. No.: US 2002/0158445 A1
(43) Pub. Date: Oct. 31, 2002

(54) Detachable front guider arrangement of stroller

(76) Inventor: Ben M. Hsia, Northridge, CA (US)

Correspondence Address: David and Raymond, Patent Group, 1050 Oakdale Lane, Arcadia, CA, 91006, US

(21) Appl. No.: 09/844,651

(22) Filed: Apr. 27, 2001

(51) Int. Cl. B62B 7/02

(52) U.S. Cl. 280/647; 280/47.25

(57) ABSTRACT

A detachable front guider arrangement incorporates with a stroller, which includes a front guider and a pair of coupling means for detachably coupling two ends of the front guider with two front leg frames of a front frame of the stroller respectively. Each of the coupling means includes a locking latch outwardly protruded from the respective front leg frame and a joint member mounted on the end of the front guider and detachably coupled with the front leg frame. A locking groove is formed on the joint member and arranged to engage with the locking latch so as to lock up the joint member on the front leg frame. Therefore, the front guider is capable of detachably attaching to the front frame of the stroller by securely mounting the joint members on the front leg frames respectively.

### BACKGROUND OF THE PRESENT INVENTION

1. Field of Invention

The present invention relates to strollers, and more particularly to a detachable front guider arrangement for a stroller wherein the front guider is facilitated to be attached to and detached from the stroller, so as to interchange the front guider such as a hand bar or a food tray to fit the need of the user.

2. Description of Related Arts

Stroller, which is becomes a necessity to every family having a young child or baby, is consider as a conveniences tool to carry the baby or young child during outdoor activities such as foot traveling and shopping.

A conventional stroller comprises a front guider mounted on a front portion of a seat frame to protect the baby or young child and thus functions as a hand bar for he or her to handle. Especially, when foot traveling, a vibration force may transfer to the stroller through the wheels such that the hand bar is extremely important to protect the young child and keep the young child in balance.

However, due to the position of the front guider with respect to the seat frame, the front guider may block the young child to get in and out the stroller. So, the parent must hug overhanging the young child into the stroller. Even though the front guider can be detached from the stroller, the original structure of the stroller must be altered to incorporate with the front guider, which will complicate the attaching/detaching operation. Thus, the attachment between the stroller and the front guider must be rigid enough to protect the young child. Since the young child is soft and weak, any mistake of the front guider may cause unwanted injury to the young child.

Thus, the hand bar has nothing to do when the young child is eating. When serving the young child, the parent must carry the food on one while another hand must take care the young child, which is a hassle especially for single parent. So, a food tray is a good idea to incorporate with the stroller for placing the food on the tray.

### SUMMARY OF THE PRESENT INVENTION

A main object of the present invention is to provide a detachable front guider arrangement specifically incorporated with a stroller wherein the front guider can be quickly and easily attached to and detached from the stroller.

Another object of the present invention is to provide a detachable front guider arrangement for a stroller, wherein the attachment of the front guider is improved in both safety and operability. The front guider is interlocked with the stroller as in one single action and is advantageous in practical use.

Another object of the present invention is to provide a detachable front guider for a stroller, which does not require to alter the original structural design of the stroller, so as to minimize the manufacturing cost of incorporating the front guider with the stroller.

Another object of the present invention is to provide a detachable front guider arrangement for a stroller, wherein the front guider is interchangeable such as a hand bar or a food tray so as to fit the need of the user.

Accordingly, in order to accomplish the above objects, the present invention provides a stroller which comprises a front frame having two front leg frames and a back frame constructed to support a seat frame thereon.

The stroller further comprises a detachable front guider arrangement which comprises a front guider and a pair of coupling means for detachably coupling two ends of the front guider with the two front leg frames of the front frame respectively, each of the coupling means comprising a locking latch outwardly protruded from the respective front leg frame and a joint member mounted on the end of the front guider and detachably coupled with the front leg frame wherein a locking groove is formed on the joint member and arranged to engage with the locking latch so as to lock up the joint member on the front leg frame.

### BRIEF DESCRIPTION OF THE DRAWINGS

FIG. 1 is a perspective view of a stroller incorporated with a detachable front guider arrangement according to a first preferred embodiment of the present invention.

FIG. 2 is an exploded perspective view of the detachable front guider arrangement of the above first preferred embodiment of the present invention.

FIG. 3 is perspective view of a coupling means of the detachable front guider arrangement mounted on the stroller according to the above first preferred embodiment of the present invention.

FIG. 4 is a perspective view of a detachable front guider arrangement of a second preferred embodiment of the present invention.

FIG. 5 is an exploded perspective view of the detachable front guider arrangement according to the above second preferred embodiment of the present invention.

FIG. 6 is a partially perspective view of the detachable front guider arrangement according to the above second preferred embodiment of the present invention.

### DETAILED DESCRIPTION OF THE PREFERRED EMBODIMENT

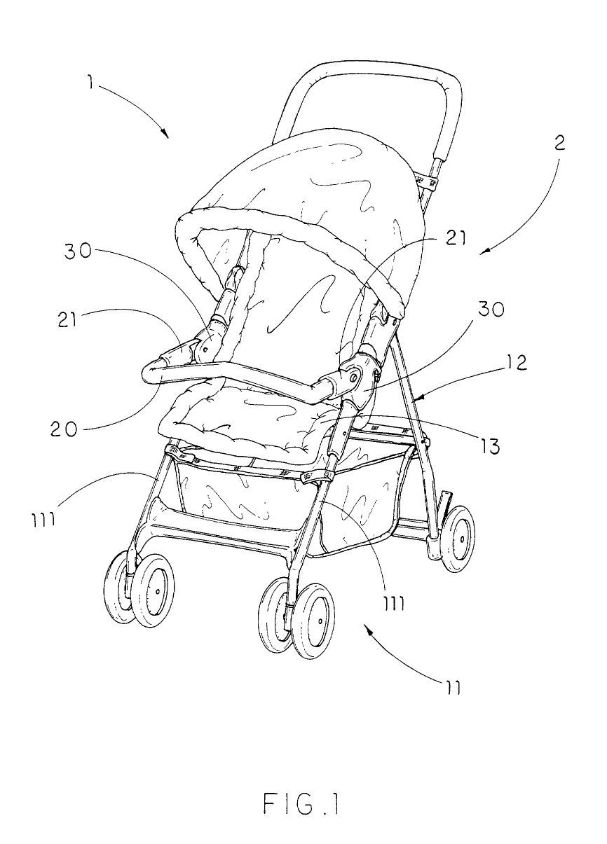

Referring to FIG. 1 of the drawings, a stroller 1 incorporated with a detachable front guider arrangement 2 according to a preferred embodiment of the present invention is illustrated. The stroller 1, such as a standard stroller, comprises a front frame 11 having a pair of front leg frames 111 and a back frame 12 constructed to support a seat frame 13 thereon.

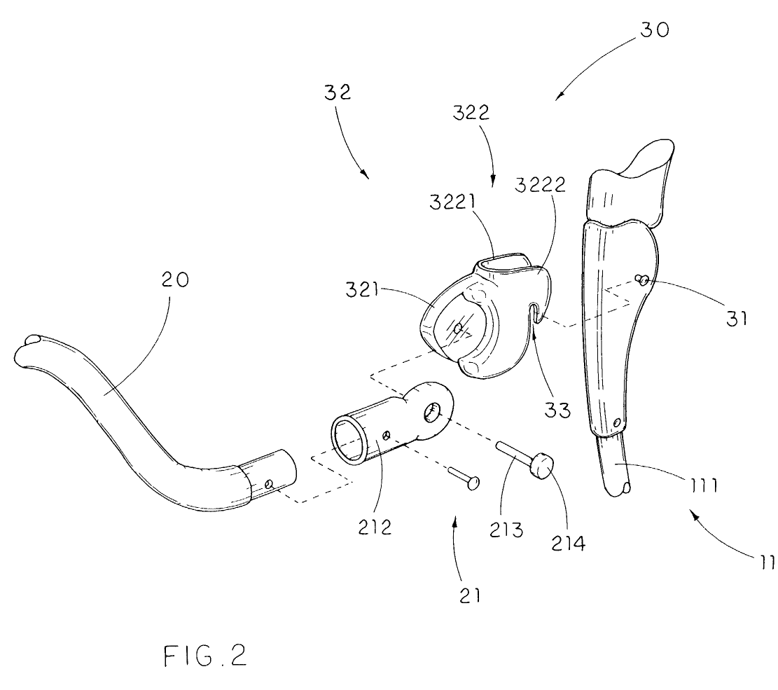

As shown in FIG. 2, the detachable front guider arrangement 2 comprises a front guider 20 and a pair of coupling means 30 for detachably coupling two ends of the front guider 20 with the two front leg frames 111 of the front frame 11 respectively. Each of the coupling means 30 comprises at least a locking latch 31 outwardly protruded from the respective front leg frame 111 and a joint member 32 mounted on the end of the front guider 20 and detachably coupled with the front leg frame 111 wherein at least a locking groove 33 is formed on the joint member 32 and arranged to engage with the locking latch 31 so as to lock up the joint member 32 on the front leg frame 111.

According to the preferred embodiment, the locking latches 31 are opposedly and outwardly protruded from the two front leg frames 111 of the front frame 11 respectively. Each of the locking latches 31 is a rivet perpendicularly mounted on an outer side of the respective front leg frame 111 wherein a predetermined length of a neck portion of the rivet is protruded from the front leg frame 111.

Each of the joint members 32 comprises a head joint 321 to connect the end of the front guider and a base joint 322 having a U-shaped cross section comprising two parallel supporting walls 3221, 3222 to fittedly mount the respective front leg frame 111 therebetween wherein the locking groove 33 is formed on one of the supporting walls 3221, 3222 in such a manner that when the base joint 322 is mounted on the front leg frame 111, the locking latch 31 is engaged into the locking groove 33 in a vertical movable manner, so as to lock up the joint member 32 on the front leg frame 111.

Accordingly, the locking groove 33 is an elongated groove formed on a mid-portion of the supporting wall 3222 at an edge thereof wherein an opening of the locking groove 33 is provided at a bottom end thereof to provide a quick and easy attachment that requires a slide-down action to engage the locking groove 33 with the locking latch 31 when the base joint 322 is slidably mounted on the front leg frame 111.

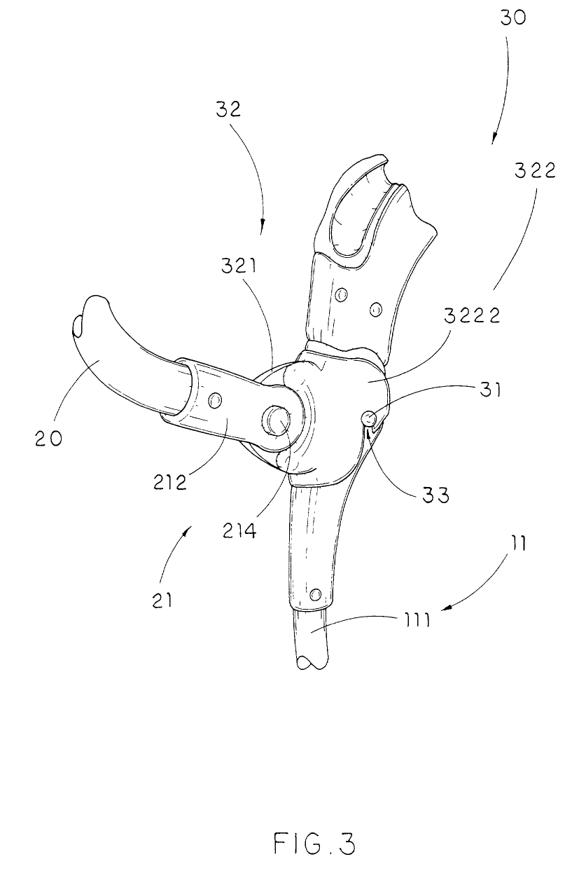

As shown in FIG. 3, the two supporting walls 3221, 3222 of the base joint 322 has a width slightly larger than a width of the front leg frame 111 such that when the joint member 32 is mounted on the front leg frame 111, two inner surfaces of the supporting walls 3221, 3222 are biased against the front leg frame 111 in a sandwiched manner. So, when the locking latch 31 is engaged with the locking groove 33, the front guider 20 is securely mounted on the front frame 11 so as to prevent an unwanted movement of the front guider 20 with respect to the front frame 11.

As shown in FIG. 2, the front guider 20 is a hand bar having two ends rotatably connected to two coupling means 30 by a pair of pivot joints 21 wherein each of the pivot joint 21 comprises a guider holder 212, which is firmly attached to the end of the front guider 20, pivotally attached to the head joint 321 of the joint member 32 by a shaft 213, and a locker button 214 provided on an outer side of the guider holder 212 and arranged for selectively locking and unlocking a rotation movement of the front guider 20 with respect to the coupling means 30. In other words, for rotating the front guider 20, inward forces must be intentionally applied on the two locker buttons 214 in order to freely rotate the front guider 20. So, the parent is able to rotatably adjust the front guider 20 at an adequate position for the young child to handle.

In order to attach the detachable front guider arrangement 2 to the stroller 1, a pulling force F1 must be intentionally applied on the coupling means 30 to the front frame 11 so as to mount the front leg frames 111 between the two supporting walls 3221, 3222 of the base joints 322 of the joint members 32 respectively. Then, a slide-down force F2 is applied on the coupling means 30 to engage the locking grooves 33 with the locking latches 31 for locking the coupling means 30 on the front leg frames 111 respectively, so as to securely attach the front guider 20 to the front frame 11 of the stroller 1. It is worth to mention that in order to detach the detachable front guider arrangement 2 from the stroller 1, the coupling means 30 must be pulled upwardly in a position that the locking latches 31 are moved out of the locking grooves 33 respectively so as to prevent the front guider 20 being detached from the front frame 11 of the stroller accidentally, especially by the young child.

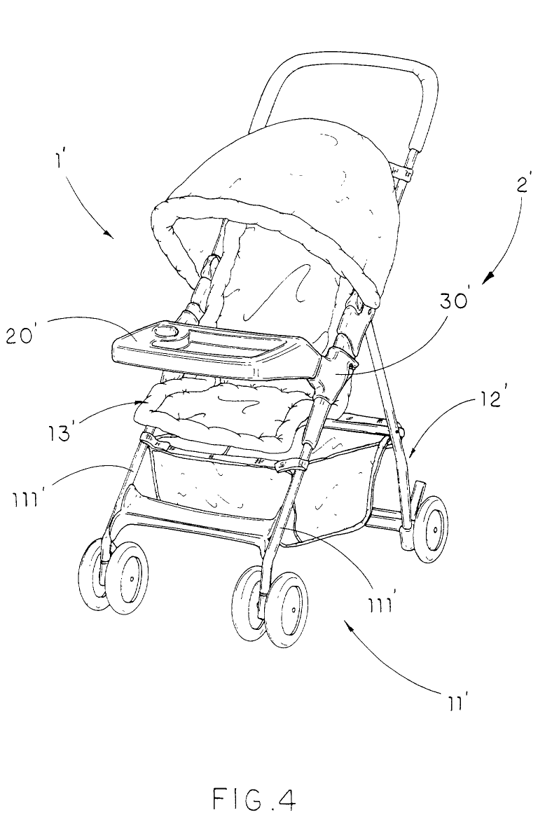

Referring to FIG. 4, a second embodiment illustrates an alternative mode of the detachable front guider arrangement 2′ of the first embodiment, wherein the front guider 20′, which is a food tray instead of the hand bar of the first embodiment, is detachably attached to the coupling means 30′ in such a manner that the food tray of the front guider 20′ can be detached from the stroller 1′ for cleaning purpose.

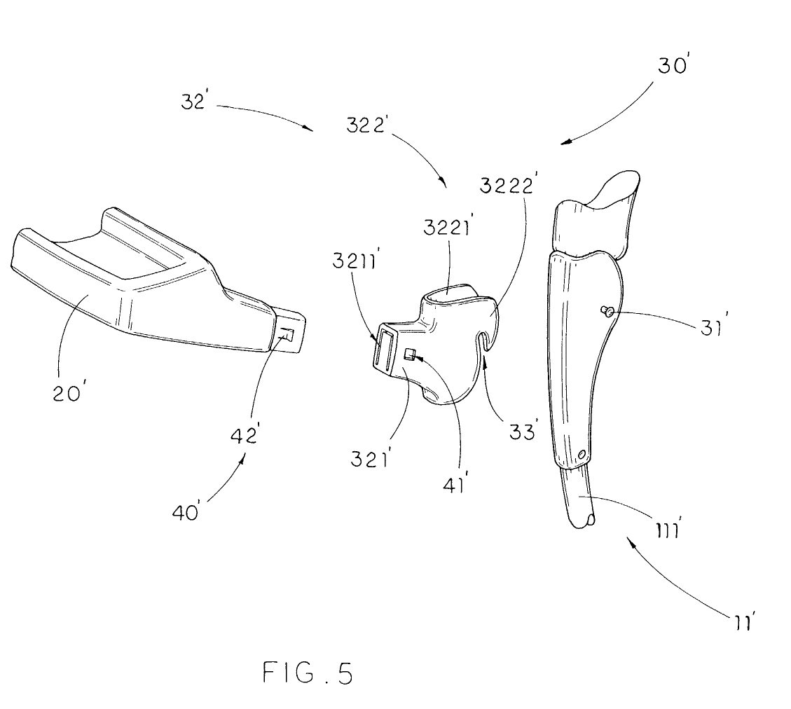

As shown in FIG. 5, the head joint 321′ of the joint member 32′ comprises a Ushaped extending slot 3211′ wherein the end of the front guider 20′ having a U-shaped cross section is fittedly inserted into the extending slot 3211′ so as to attach the front guider 20′ to the coupling means 30′.

The detachable front guider arrangement 2′ further comprises a pair of locking means 40′ for locking up the two end of the front guider 20′ to the coupling means 30′ respectively wherein each of the locking means 40′ has through locking slot 41′ formed on a sidewall of the end portion of the joint member 32′ and a locking flange 42′ formed on a corresponding sidewall of an end portion of the front guider 20′ wherein the locking flange 42′ is engaged with the locking slot 41′ when the end of the front guider 20′ is inserted into the extending slot 3211′ of the joint member 32′, so as to securely lock up the front guider 20′ to the coupling means 30′.

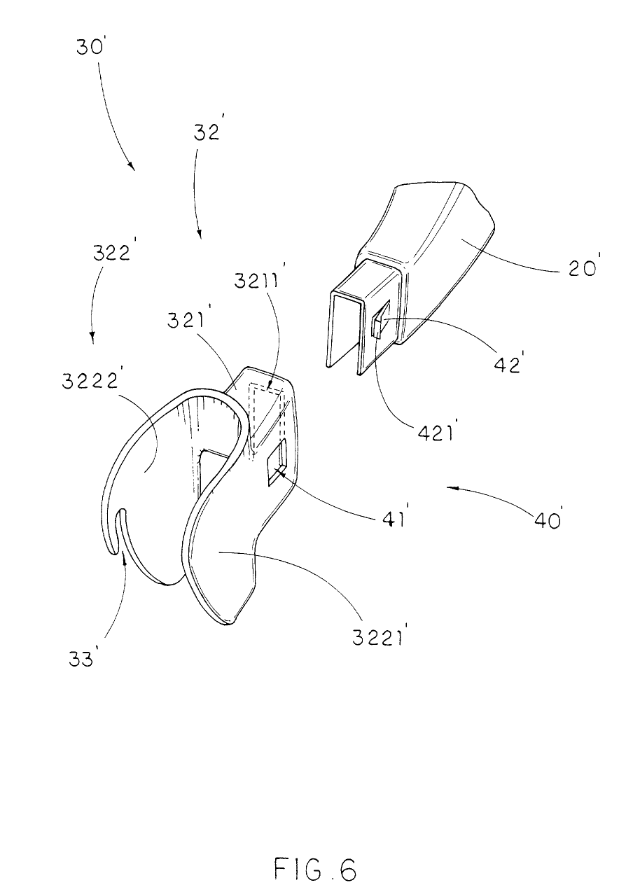

Accordingly, the locking flange 42′ is formed by cutting through the sidewall of the front guider 20′ wherein one end of the locking flange 42′ is integrally extend from the sidewall of the front guider 20′ while an opposed free end of the locking flange 42′ is in a suspended manner, so as to provide a flexibility of the locking flange 42′. Thus, a locking tip 421′ is integrally protruded from the free end of the locking flange 42′ for blocking on the locking flange 42′ out of the locking slot 41′, so as to lock up the front guider 20′ to the coupling means 30′, as shown in FIG. 6.

What is claimed is:

1. A stroller, comprising:
a front frame having two front leg frames and a back frame constructed to support a seat frame thereon; and
a detachable front guider arrangement, comprising:
a front guider; and
a pair of coupling means for detachably coupling two ends of said front guider with said two front leg frames of said front frame respectively, each of said coupling means comprising at least a locking latch outwardly protruded from said respective front leg frame and a joint member mounted on said end of said front guider and detachably coupled with said front leg frame wherein at least a locking groove is formed on said joint member and arranged to engage with said locking latch so as to lock up said joint member on said front leg frame.

2. A stroller, as recited in claim 1, wherein said two locking latches are two rivets perpendicularly mounted on two outer sides of said two front leg frames respectively wherein a predetermined length of a neck portion of each said rivet is protruded from said respective front leg frame to engage with said locking groove.

3. A stroller, as recited in claim 1, wherein each of said joint members comprises a head joint to connect said respective end of said front guider and a base joint having a U-shaped cross section comprising two parallel supporting walls to fittedly mount said respective front leg frame therebetween.

4. A stroller, as recited in claim 2, wherein each of said joint members comprises a head joint to connect said respective end of said front guider and a base joint having a U-shaped cross section comprising two parallel supporting walls to fittedly mount said respective front leg frame therebetween.

5. A stroller, as recited in claim 3, wherein said locking groove is an elongated groove formed at an edge of said supporting wall wherein an opening of said locking groove is provided at a bottom end thereof in such a manner that said joint member is engaged with said front leg frame in a slide-down manner.

6. A stroller, as recited in claim 4, wherein said locking groove is an elongated groove formed at an edge of said supporting wall wherein an opening of said locking groove is provided at a bottom end thereof in such a manner that said joint member is engaged with said front leg frame in a slide-down manner.

7. A stroller, as recited in claim 3, wherein said front guider is a hand bar having two ends rotatably connected to said two coupling means by a pair of pivot joints respectively wherein each of said pivot joint comprises a guider holder firmly attached to said end of said front guider and pivotally attached to said head joint of said joint member so as to rotatably connect said front guider to said coupling means.

8. A stroller, as recited in claim 4, wherein said front guider is a hand bar having two ends rotatably connected to said two coupling means by a pair of pivot joints respectively wherein each of said pivot joint comprises a guider holder firmly attached to said end of said front guider and pivotally attached to said head joint of said joint member so as to rotatably connect said front guider to said coupling means.

9. A stroller, as recited in claim 6, wherein said front guider is a hand bar having two ends rotatably connected to said two coupling means by a pair of pivot joints respectively wherein each of said pivot joint comprises a guider holder firmly attached to said end of said front guider and pivotally attached to said head joint of said joint member so as to rotatably connect said front guider to said coupling means.

10. A stroller, as recited in claim 7, wherein said pivot joint further comprises a locker button provided on an outer side of said guider holder and arranged for selectively locking and unlocking a rotation movement of said front guider with respect to said coupling means.

11. A stroller, as recited in claim 8, wherein said pivot joint further comprises a locker button provided on an outer side of said guider holder and arranged for selectively locking and unlocking a rotation movement of said front guider with respect to said coupling means.

12. A stroller, as recited in claim 9, wherein said pivot joint further comprises a locker button provided on an outer side of said guider holder and arranged for selectively locking and unlocking a rotation movement of said front guider with respect to said coupling means.

13. A stroller, as recited in claim 3, wherein said front guider is a foot tray having two ends detachably connected to said two coupling means wherein said head joint of said joint member comprises a U-shaped extending slot such that said end of said front guider having a U-shaped cross section is fittedly inserted into said extending slot so as to detachably attach said front guider to said coupling means.

14. A stroller, as recited in claim 6, wherein said front guider is a foot tray having two ends detachably connected to said two coupling means wherein said head joint of said joint member comprises a U-shaped extending slot such that said end of said front guider having a U-shaped cross section is fittedly inserted into said extending slot so as to detachably attach said front guider to said coupling means.

15. A stroller, as recited in claim 13, wherein said detachable front guider arrangement further comprises a pair of locking means for locking up said two end of said front guider to said coupling means respectively wherein each of said locking means has through locking slot formed on a sidewall of said hollow holder of said joint member and a locking flange having a locking tip formed on a corresponding sidewall of said front guider in such a manner that said locking flange is engaged with said locking slot when said end of said front guider is inserted into said hollow holder of said joint member, so as to securely lock up said front guider to said coupling means.

16. A stroller, as recited in claim 14, wherein said detachable front guider arrangement further comprises a pair of locking means for locking up said two end of said front guider to said coupling means respectively wherein each of said locking means has through locking slot formed on a sidewall of said hollow holder of said joint member and a locking flange formed on a corresponding sidewall of an end portion of said front guider in such a manner that said locking flange is engaged with said locking slot when said end of said front guider is inserted into said hollow holder of said joint member, so as to securely lock up said front guider to said coupling means.

17. A stroller, as recited in claim 15, wherein said locking flange is formed by cutting through said sidewall of said front guider wherein one end of said locking flange is integrally extend from said sidewall of said front guider while an opposed free end of said locking flange is in a suspended manner, so as to provide a flexibility of said locking flange.

18. A stroller, as recited in claim 16, wherein said locking flange is formed by cutting through said sidewall of said front guider wherein one end of said locking flange is integrally extend from said sidewall of said front guider while an opposed free end of said locking flange is in a suspended manner, so as to provide a flexibility of said locking flange.

19. A stroller, as recited in claim 17, wherein each of said locking flanges has a locking tip is integrally protruded from said free end of said locking flange for blocking on said locking flange out of said locking slot, so as to lock said front guider to said coupling means.

20. A stroller, as recited in claim 18, wherein each of said locking flanges has a locking tip is integrally protruded from said free end of said locking flange for blocking on said locking flange out of said locking slot, so as to lock said front guider to said coupling means.
